(19) United States
(12) Patent Application Publication
(10) Pub. No.: US 2013/0099900 A1
(43) Pub. Date: Apr. 25, 2013

(54) Actuator Sensor Apparatus for a Dispenser Bottle for Wireless Automatic Reporting of Dispenser Usage

(71) Applicant: Ronald J. Pulvermacher, Sun Prairie, WI (US)

(72) Inventor: Ronald J. Pulvermacher, Sun Prairie, WI (US)

(73) Assignee: MATRIX PRODUCT DEVELOPMENT, Sun Prairie, WI (US)

(21) Appl. No.: 13/323,928

(22) Filed: Dec. 13, 2011

Related U.S. Application Data
(60) Provisional application No. 61/627,937, filed on Oct. 21, 2011.
(60) Provisional application No. 61/553,736, filed on Oct. 31, 2011.

(51) Int. Cl. G06K 7/01

(52) U.S. Cl. 340/10.42

(57) ABSTRACT

Actuation sensor apparatus configured to removably attach to a liquid dispenser, the apparatus comprising (a) an electronic circuit including a dispense sensor and a wireless transmitter and (b) a power supply for the electronic circuit, whereby, when dispenser actuation occurs, an identification code unique to the apparatus is wirelessly transmitted to a receiver. In a preferred embodiment, the dispense sensor is a magnetic sensor and the apparatus further includes an actuator arm having a magnet, and the actuator arm is configured to move with respect to the magnetic sensor during actuation.

### RELATED APPLICATIONS

This application claims the benefit of U.S. Provisional Applications 61/627,937 filed on Oct. 21, 2011 and 61/553,736 filed on Oct. 31, 2011, the entire contents of which are incorporated herein by reference.

### FIELD OF THE INVENTION

This invention is related generally to hand hygiene compliance monitoring and more particularly to apparatus for generating signals from a liquid dispenser.

### BACKGROUND OF THE INVENTION

In recent years, the importance of good hand hygiene has become increasing evident. This is true throughout the world and in all sectors of society but is of particular importance within the field of health care. For example, in 2009, the World Health Organization released its first report on the topic (“WHO Guidelines on Hand Hygiene in Health Care: First Global Patient Safety Challenge—Clean Care is Safer Care.” Page 6 of this report states the following: “HCAI [health care-associated infection] is a major problem for patient safety and its surveillance and prevention must be a first priority for settings and institutions committed to making health care safer . . . Overall estimates indicate that more than 1.4 million patients worldwide in developed and developing countries are affected at any one time . . . The annual economic impact of HCAI in the USA was approximately $6.5 billion in 2004.” This report continues by discussing at length, among other topics, the significance of hand hygiene on the transmission of health care-associated pathogens.

In light of the importance of hand hygiene, the monitoring of hand hygiene in venues such as health care facilities and restaurants from a number of perspectives has been area of significant health and economic interest. Among the wide variety of monitoring systems, there are systems which measure usage frequency, hand-washing timing, identity of users, hand-washing technique, and etc. However, there remains a need for reliable, low-cost apparatus which can be used with replaceable soap or sanitizer dispenser bottles.

Hand hygiene compliance monitoring requires the reporting of soap and/or sanitizer usage. The standalone bottle-type dispenser is among the most challenging of compliance applications because to be economically viable, any transmitter used must be moved to a different bottle when the bottle is empty. Further, if the dispenser bottle is near a sink with water and/or corrosive soap, the actuation detection mechanism must be sealed from the environment.

This document describes a quick-attach mechanism for an actuation sensing device and wireless transmission of use information to report (a) liquid dispensing from a bottle, (b) battery condition in the device, and © motion-monitoring to provide theft deterrence.

### OBJECTS OF THE INVENTION

It is an object of this invention to provide reliable and low-cost actuation dispenser sensor apparatus which can be removably attached to a liquid dispenser so that when the dispenser is replaced with another, the apparatus may be easily attached to the replacement dispenser.

Another object of this invention is to provide actuation sensor apparatus which can rotate on the dispenser to which it is attached without affecting operation.

Another object of this invention is to provide actuation sensor apparatus which can snap on and off the dispenser to which it is attached.

It is a further object of this invention to provide actuation sensor apparatus which is sealed from the environment in which it is operating.

Yet another object of this invention to provide actuation sensor apparatus which has a small outer surface to minimize the area which may attract dirt and other contaminants.

A further object of this invention is to provide actuation sensor apparatus which may be adapted to a wide variety of transmission modes by which to communicate usage data to other systems to which the sensor apparatus is connected.

Another object of this invention is to provide actuation sensor apparatus which can transmit a signal if it is moved as a means of theft prevention.

Another object of this invention is to provide actuation sensor apparatus which can be used as a component in a system incorporating real-time location monitoring of users.

Another object of this invention is to provide actuation sensor apparatus which has extended battery life and may be able to report the condition of its battery.

And yet another object of this invention is to provide actuation sensor apparatus which can harvest the energy input by a user during actuation to power itself.

These and other objects of the invention will be apparent from the following descriptions and from the drawings.

### SUMMARY OF THE INVENTION

The invention disclosed herein is actuation sensor apparatus configured to removably attach to a liquid dispenser, and the apparatus has an electronic circuit which includes a dispense sensor and a wireless transmitter. The apparatus also has a power supply for the electronic circuit. When dispenser actuation occurs, an identification code unique to the apparatus is wirelessly transmitted to a receiver.

In a highly-preferred embodiment of the inventive actuation sensor apparatus, the dispense sensor is a magnetic sensor and the apparatus further includes an actuator arm having a magnet. The actuator arm is configured to move with respect to the magnetic sensor during actuation. In some such embodiments, at least a portion of the actuator arm is over-molded with a polymer material, and in other such embodiments, at least a portion of the actuator arm is inserted into a heat-shrink sleeve. Further, in some of these embodiments, the actuator arm removably attaches to the liquid dispenser with a wireform assembly. In some of these preferred embodiments, the magnetic sensor is a reed switch, and in some of these embodiments, the magnetic sensor is an integrated circuit such as a Hall effect sensor.

In some embodiments of the inventive actuation sensor apparatus, the wireless transmitter is an electric field transmitter. The electric field transmitter may be, but is not limited to, one of the following transmitters: (a) an IEEE 802.11x transmitter (the “x” refers to the version of the standard), (b) an IEEE ZigBee® transmitter, © an IEEE 802.15.4 transmitter, (d) a 433 MHZ radio transmitter, (e) an ISO18000-7 transmitter (Dash 7), (f) an ANT™ transmitter (protocol by Dynastream Innovations Inc), and (g) an EnOcean® Alliance transmitter.

In some embodiments of the inventive actuation sensor apparatus, the wireless transmitter is an ultrasonic transmitter, and in some embodiments, the wireless transmitter is an infrared transmitter.

In some embodiments of the inventive actuation sensor apparatus, the wireless transmitter is a magnetic field transmitter. In some of these embodiments, the magnetic field transmitter may be a low-frequency or a high-frequency transmitter.

Some preferred embodiments of the inventive apparatus include a motion sensor which enables the wireless transmitter to transmit a signal when the apparatus is moved for at least a predetermined time period. In some such embodiments, the predetermined time period is at least about two seconds, thereby to allow non-theft movements to be overlooked.

Some highly-preferred embodiments of the actuation sensor apparatus include an electronic circuit enclosure and a dispenser mounting clip which are removably attached to each other. In some embodiments, the apparatus includes an electronic circuit enclosure which is sealed to prevent liquid from contacting the electronic circuit.

In some preferred embodiments, the power supply is a battery. In some such embodiments, the battery is rechargeable. In some such embodiments, the electronic circuit is configured to transmit the battery-charge level upon dispenser actuation.

In other embodiments, the power source includes a capacitor and circuitry to generate electric charge during dispenser actuation and store the charge in the capacitor.

Further, in other embodiments, the electronic circuit enters an ultra-low-power mode between dispenser actuations.

In some embodiments of the inventive actuation sensor apparatus, the dispense sensor is a mechanical switch.

In some embodiments, the power source comprises circuitry to generate electric power by converting mechanical energy to electric energy during dispenser actuation. In some such embodiments, the electronic circuit, dispenser sensor and power source are an integrated unit.

In some embodiments, the dispense sensor is an optical sensor in which a light beam is interrupted by dispenser activation.

The present invention also encompasses a hand-hygiene monitoring system which comprises: (a) actuation sensor apparatus configured to removably attach to a liquid dispenser, the apparatus having an electronic circuit including a dispense sensor and a wireless transmitter and a power supply for the electronic circuit; (b) a plurality of real-time location system tags, each tag associated with a particular user; and © a base unit configured to communicate with one or more of the actuation sensor apparatus and the plurality of tags and to communicate with a network. When the dispenser is actuated by one of the plurality of users, identification codes unique to the apparatus and to the one of the plurality of users are transmitted to the network.

In preferred embodiments of the inventive hand-hygiene monitoring system, the dispense sensor is a magnetic sensor and the apparatus further includes an actuator arm having a magnet. The actuator arm is configured to move with respect to the magnetic sensor during actuation.

In some embodiments of the inventive hand-hygiene monitoring system, the wireless transmitter is an infrared transmitter, the base unit includes a short-range magnetic field transmitter and an real-time location system receiver. The base unit is configured to transmit data received from the actuation sensor apparatus to one of the plurality of tags when the dispenser is actuated. In similar embodiments, the wireless transmitter may be an electric field transmitter.

As used herein, the abbreviation RF refers to radio frequency wireless communication, and, more specifically herein, refers to electric field transmission as opposed to magnetic field transmission.

Magnetic field transmission refers to low-frequency or high-frequency communication which relies primarily on the magnetic field to transmit data. Such a signal is normally received by a coil antenna.

Electric field transmission normally primarily utilizes the electric field at UHF or microwave frequencies to transmit data. Such signals are normally received by a conductor which has a length of one, one-half, or one-quarter wavelength.

Short range refers to communication at distances less than a few meters. Long range refers to communication at distances greater than a few meters.

The term ultrahigh frequency (UHF) refers to electromagnetic waves between about 300 MHz and 3 GHz.

High frequency (HF) refers to radio frequencies between about 3 MHz and 30 MHz. Low frequency (LF) refers to radio frequencies between about 30 kHz and 300 kHz.

Ultra-low power refers to electronic circuits, often including microprocessors, which consume less than one micro-ampere while in ultra-low-power mode.

As used herein, the term “real-time location system” refers to a system which is configured to wirelessly identify the location of a typically user-worn tag within a predetermined environment such as a health-care facility.

### BRIEF DESCRIPTION OF THE DRAWINGS

FIG. 1 is a perspective drawing of one embodiment of the inventive actuation sensor apparatus. The apparatus is shown attached to a liquid dispenser.

FIG. 2 is an exploded-view side elevation drawing of the apparatus of FIG. 1. The dispense sensor is a magnetic sensor. The apparatus is shown attached to a liquid dispenser.

FIG. 2A is a drawing of an alternative embodiment of the wireform assembly shown in FIG. 2.

FIG. 3 is a perspective drawing of an embodiment of the inventive actuation sensor apparatus in which the dispense sensor is a sealed mechanical switch.

FIG. 4 is a side elevation cross-sectional drawing of the embodiment of FIG. 3.

FIG. 4A is a side elevation cross-sectional drawing of an alternate embodiment of the inventive actuation sensor apparatus in which the electronic circuit, dispense sensor and power source are an integrated unit. Electric power is generated by converting mechanical energy to electric energy during dispenser actuation.

FIG. 5 is a perspective drawing of an embodiment of the inventive actuation sensor apparatus in which the dispense sensor is an optical switch.

FIG. 6 is a perspective drawing of the embodiment of FIG. 5 with the electronic circuit enclosure removed. The apparatus is shown attached to a liquid dispenser.

FIG. 7 is a top elevation drawing of the electronic circuit enclosure and dispenser mounting clip of the embodiment of FIG. 1. The enclosure and mounting clip are removably attached to each other.

FIG. 8A is a block diagram schematic of the actuation sensor apparatus of FIGS. 1 and 2. The apparatus uses an ultrasonic transmitter.

FIG. 8B is a block diagram schematic of the actuation sensor apparatus of FIGS. 1 and 2. The apparatus uses either a long-range electric field transmitter (several modalities shown) or an IR transmitter.

FIG. 8C is a block diagram schematic of the actuation sensor apparatus of FIGS. 1 and 2. The apparatus uses a short-range electric field transmitter (multiple modalities shown) with an optional IR transmitter.

FIG. 8D is a block diagram schematic of the actuation sensor apparatus of FIGS. 1 and 2. The apparatus uses a magnetic field transmitter.

FIG. 9A is a circuit diagram of a WiFi transmitter embodiment of the electronic circuit in the actuation sensor apparatus of FIG. 1.

FIG. 9B is a circuit diagram of a Zigbee transmitter embodiment of the electronic circuit in the actuation sensor apparatus of FIG. 1.

FIG. 9C is a circuit diagram of an infrared transmitter embodiment of the electronic circuit in the actuation sensor apparatus of FIG. 1.

FIG. 9D is a circuit diagram of a high-frequency magnetic field transmitter embodiment of the electronic circuit in the actuation sensor apparatus of FIG. 1.

FIG. 9E is a circuit diagram of an ultrahigh frequency RF transmitter embodiment of the electronic circuit in the actuation sensor apparatus of FIG. 1.

FIG. 9F is a circuit diagram of low-frequency RF transmitter embodiment of the electronic circuit in the actuation sensor apparatus of FIG. 1.

FIG. 9G is a circuit diagram of a microprocessor and dispenser sensor. The circuit of FIG. 9G is used in conjunction with circuitry of FIGS. 9C-9F.

FIG. 9H is a circuit diagram of a Hall effect sensor adapted to serve a dispense sensor.

FIG. 10A is a schematic drawing depicting a communication configuration including a real-time location system (RTLS). The inventive actuation sensor apparatus shown includes an ultrasonic transmitter.

FIG. 10B is a schematic drawing depicting a communication configuration including an RTLS. The inventive actuation sensor apparatus shown includes a radio frequency (RF) transmitter.

FIG. 10C is a schematic drawing depicting a communication configuration including an RTLS. The inventive actuation sensor apparatus shown includes an infrared (IR) transmitter.

FIG. 10D is a schematic drawing depicting a communication configuration including an RTLS. The inventive actuation sensor apparatus shown includes an infrared transmitter and an RF transmitter to allow dispenser usage independently of RTLS operation.

FIG. 10E is a schematic drawing depicting a communication configuration including an RTLS. The inventive actuation sensor apparatus shown includes an ultra-high frequency (UHF) transmitter.

FIG. 10F is a schematic drawing depicting a communication configuration including an RTLS. The inventive actuation sensor apparatus shown includes a UHF transmitter and an RF transmitter to allow dispenser usage independently of RTLS operation.

FIG. 10G is a schematic drawing depicting an additional communication configuration including an RTLS. Similar to the embodiment of FIG. 10C, the inventive actuation sensor apparatus shown includes an infrared (IR) transmitter and LF or HF magnetic field transmitter.

FIG. 10H is a schematic drawing depicting a communication configuration including an RTLS. The inventive actuation sensor apparatus shown includes a short-range RF transmitter and an LF or HF magnetic field transmitter.

### DETAILED DESCRIPTION OF PREFERRED EMBODIMENTS

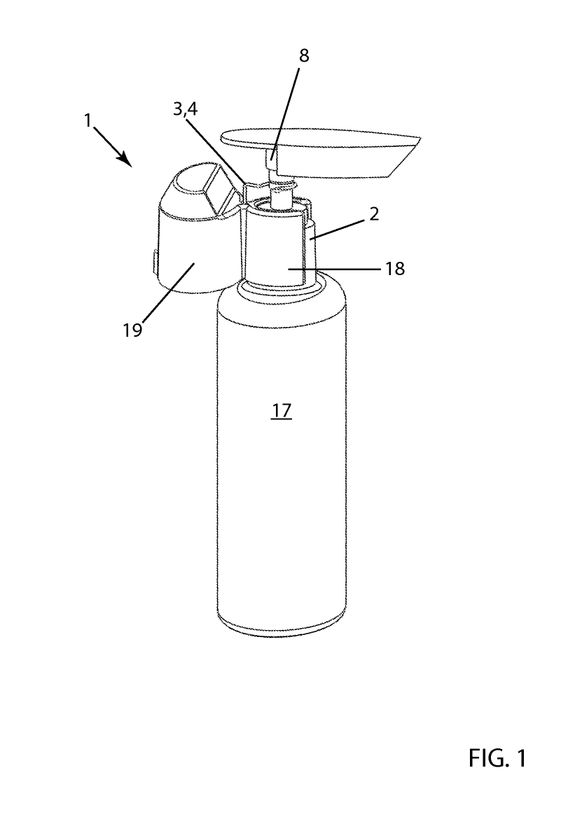

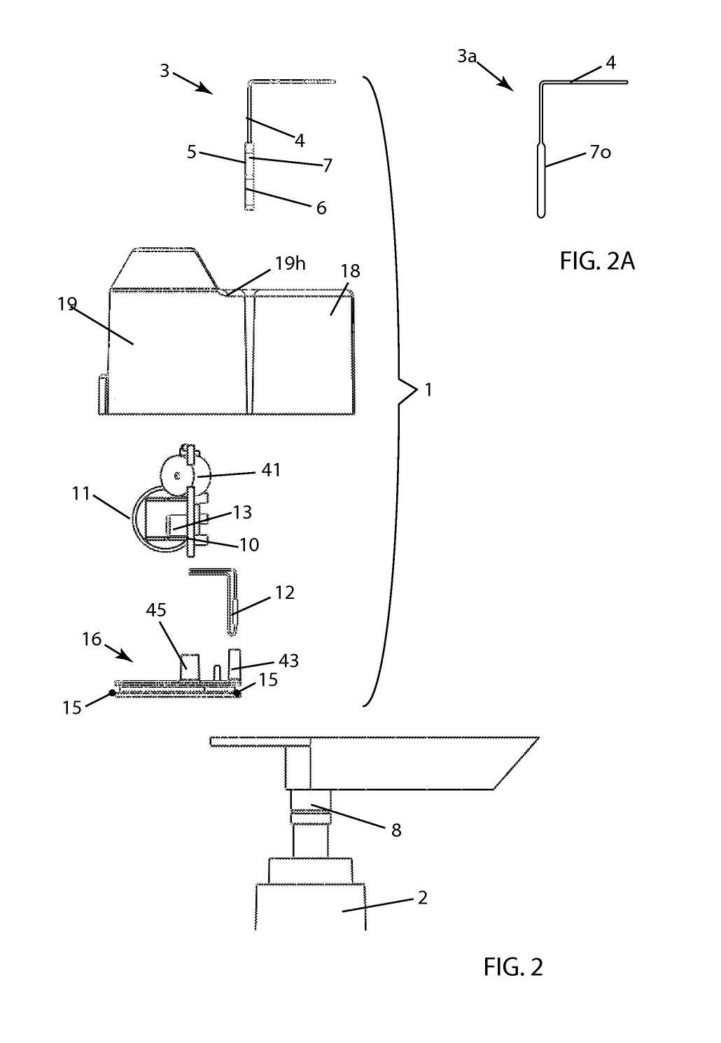

FIGS. 1, 2 and 2A illustrate one embodiment of the inventive actuation sensor apparatus. FIG. 1 is a perspective drawing of the apparatus 1 shown attached to a liquid dispenser. FIG. 2 is an exploded-view side elevation drawing of apparatus 1. The liquid dispenser to which apparatus is attached includes a liquid-containing bottle 17, a bottle cap 2 and a plunger neck 8 connected to an internal plunger (not shown). Bottle 17 may contain hand-hygiene liquids such as soap or hand sanitizer, but is not limited to such liquids. Apparatus 1 includes a sealed enclosure 19, a mounting clip 18 which snap- or friction-fits over cap 2, and a wireform assembly 3 having a wireform 4 for transmitting the motion of plunger neck 8 to an internal dispense sensor 12, which in this embodiment is a magnetic reed switch 12.

Referring now to FIG. 2 for further detail, FIG. 2 is an exploded-view side elevation drawing of apparatus 1 from FIG. 1. Wireform assembly 3 also includes a magnet 6 and a tubular spacer 5 attached to wireform 4 and covered with a section of heat-shrink tubing 7. FIG. 2A illustrates an alternative embodiment of wireform assembly 3, therein labeled wireform assembly 3a. Heat-shrink tubing section 7 of wireform assembly 3 is replaced with an over-mold section 7o of a suitable polymer material such as silicone. Wireform assembly 3a also includes magnet 6 not shown in FIG. 2A and may include spacer 5 also not shown. Referring again to FIG. 2, wireform assembly 3 is slidably inserted into a hole 19h in enclosure 19, thereby placing magnet 6 in position to activate magnetic reed switch 12 when motion of plunger neck 8 moves magnet 6 adjacent to switch 12. Wireform assembly 3 is held in place by clipping onto plunger neck 8. Apparatus 1 also includes an electronic circuit 10, a battery 11 as its power source, an ultrasonic transducer 41 (transmitter), a motion sensor 13, and a cover 16. Cover 16 includes an O-ring seal 15, a sensor slot 43 for reed switch 12, and a board slot 45 for electronic circuit 10. Cover 16 fits into the bottom of enclosure 19 and provides a seal against contamination for the environment surrounding apparatus 1.

Ultrasonic transducer 41 transmit data when dispense sensor (reed switch) 12 is actuated. When plunger neck 8 moves down when actuated to dispense liquid from bottle 17, magnet 6 closes reed switch 12 as it comes in close proximity to reed switch 12, interrupting the microprocessor in electronic circuit 10 from a deep ultra-low-current sleep mode and sends out a wireless ultrasonic message to a wireless receiver. (Further details of the electronic circuit operation can be seen in later figures.) The microprocessor in electronic circuit 10 is programmed to transmit such dispense actuation data ands also to transmit battery condition as indication of when to change battery 11 when its capacity is low.

Enclosure 19 may include regions for increased transmission of ultrasound. Such regions may be thin wall-section portions of enclosure 19 or may be openings covered with a suitable thin membrane material such as heat-shrink material which is stiff or brittle to allow transmission of sound energy.

If apparatus 1 is in motion, for example, for a period greater than two seconds, motion detector 13 interrupts the microprocessor in electronic circuit assembly 10 from its deep ultra-low-current sleep mode and causes a message to be transmitted to alert personnel that apparatus 1 is being moved, thereby alerting personnel to possible theft.

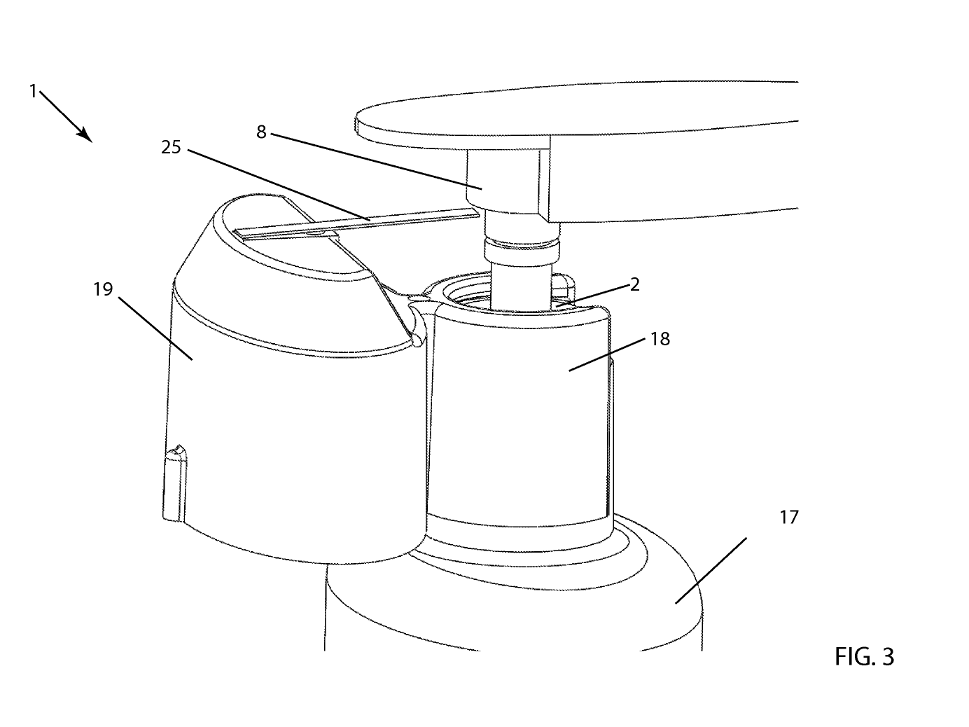

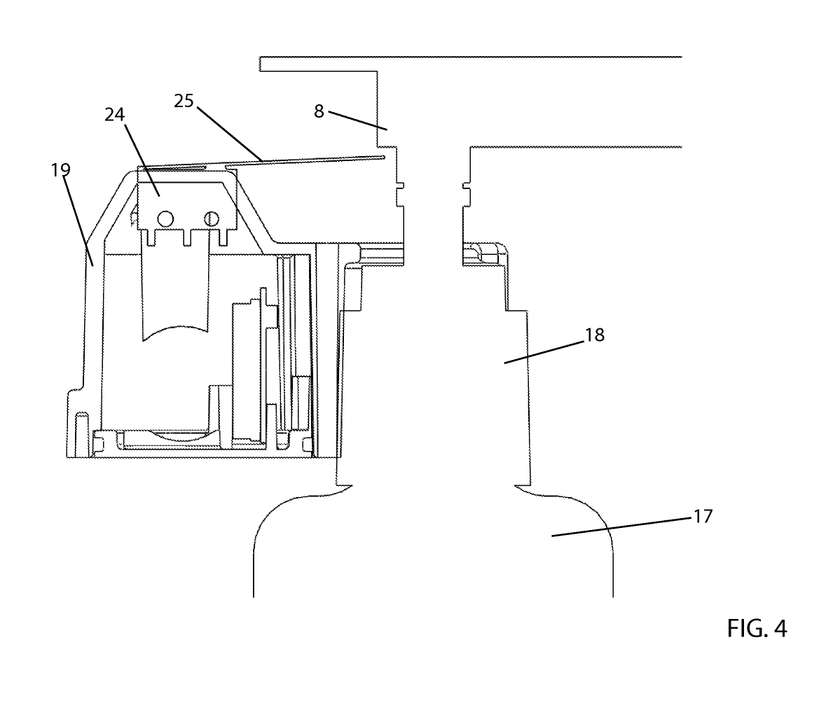

FIG. 3 is a perspective drawing of an alternative embodiment of the actuation sensor apparatus in which the dispense sensor is a sealed mechanical switch, and FIG. 4 is a side elevation cross-sectional drawing of the embodiment of FIG. 3. Referring to FIGS. 3 and 4, when plunger neck 8 is moved down during dispenser actuation, a sealed mechanical switch 24 is actuated by actuation lever 25. Switch 24 interfaces to electronic circuit in the same fashion as reed switch 12.

FIG. 4A is a side elevation cross-sectional drawing of another mechanical switch alternative embodiment. As shown in FIG. 4A, in this embodiment of the apparatus, the electronic circuit, dispense sensor and power source are an integrated unit 24i. Electric power is generated by converting mechanical energy to electric energy during dispenser actuation. Integrated unit 24i may be a module similar to Pushbutton Transmitter Module PTM 200C made by EnOcean GmbH of Oberhaching, Germany. Unit 24i would be modified from this particular part since only a single switch is required in the apparatus. Unit 24i includes all of the required elements of electronic circuit 10 including a wireless transmitter at 315 MHz. Unit 24i also includes a power source which generates electric power from the mechanical movement of plunger neck 8.

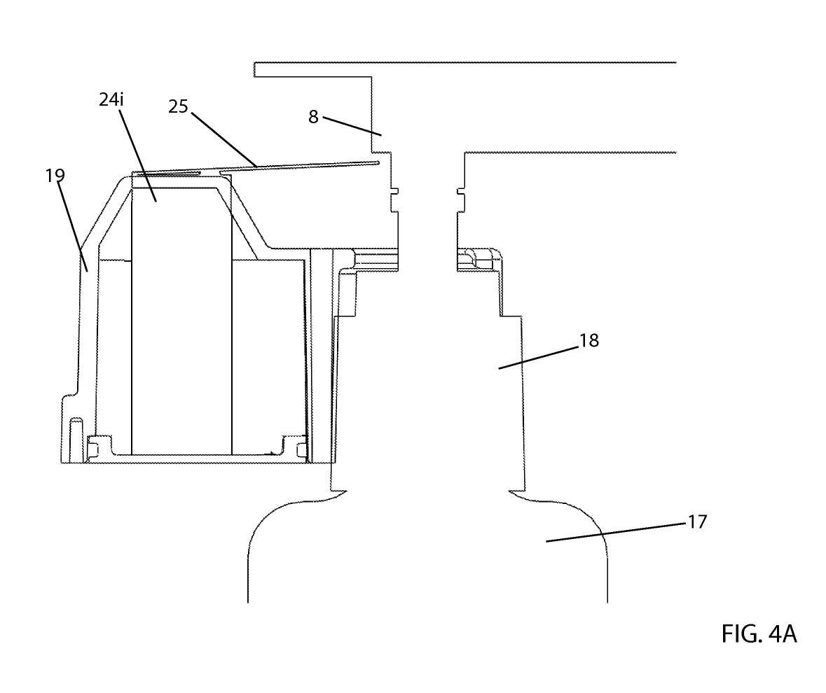

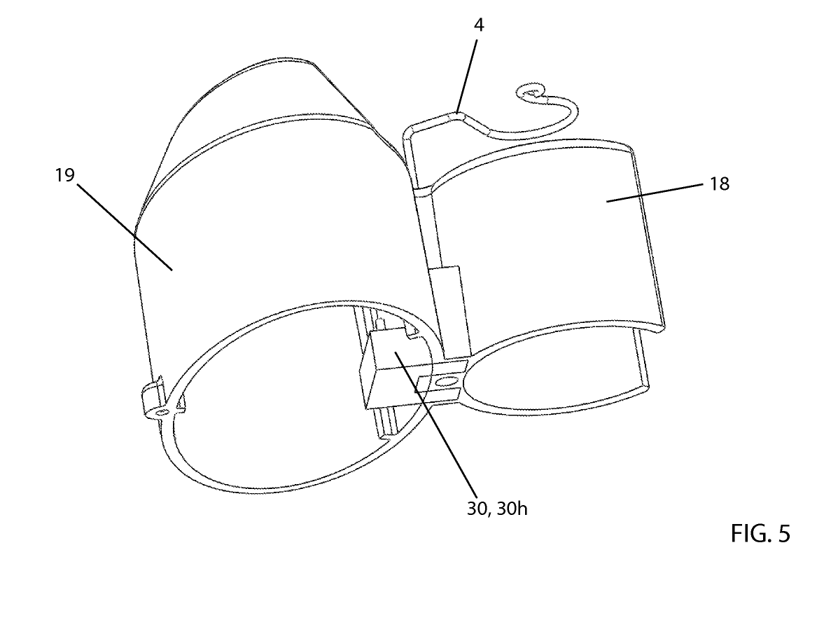

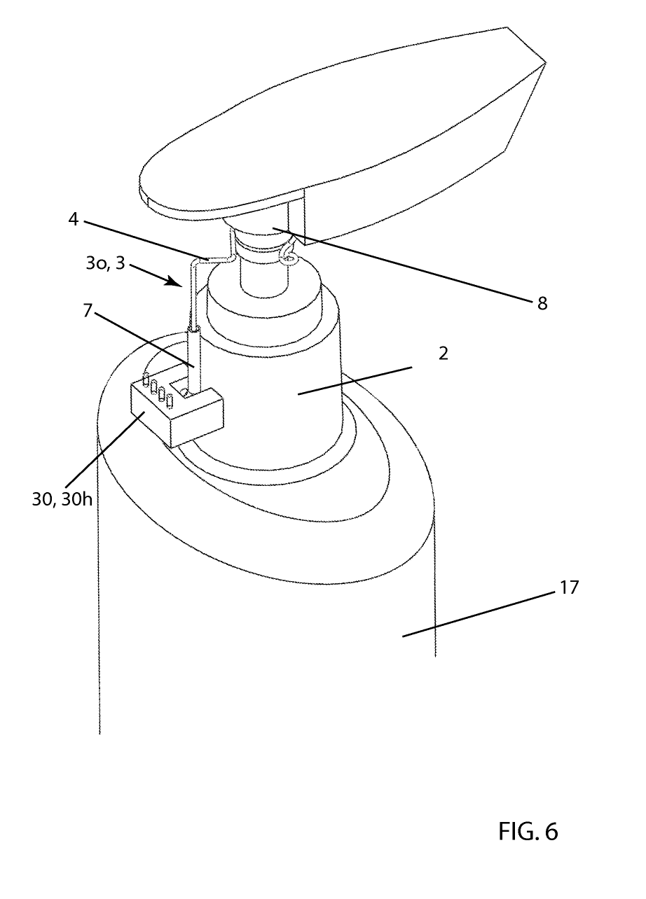

FIG. 5 is a perspective drawing of another alternative embodiment of the inventive actuation sensor apparatus in which the dispense sensor is an optical switch, and FIG. 6 is a perspective drawing of the embodiment of FIG. 5 with the electronic circuit enclosure removed. The apparatus illustrated in FIG. 5 is without bottle 17, cap 2, and plunger neck 8 while FIG. 6 includes these components but not enclosure 19 and mounting clip 18. A light sensor 30 is used to detect movement of plunger neck 8. In this alternative embodiment, wireform assembly 3 is replaced with wireform assembly 3o in which heat-shrink section 7 does not capture magnet 6 but simple optically interrupts an optical beam within light sensor 30 to provide the dispense sensor signal for the apparatus.

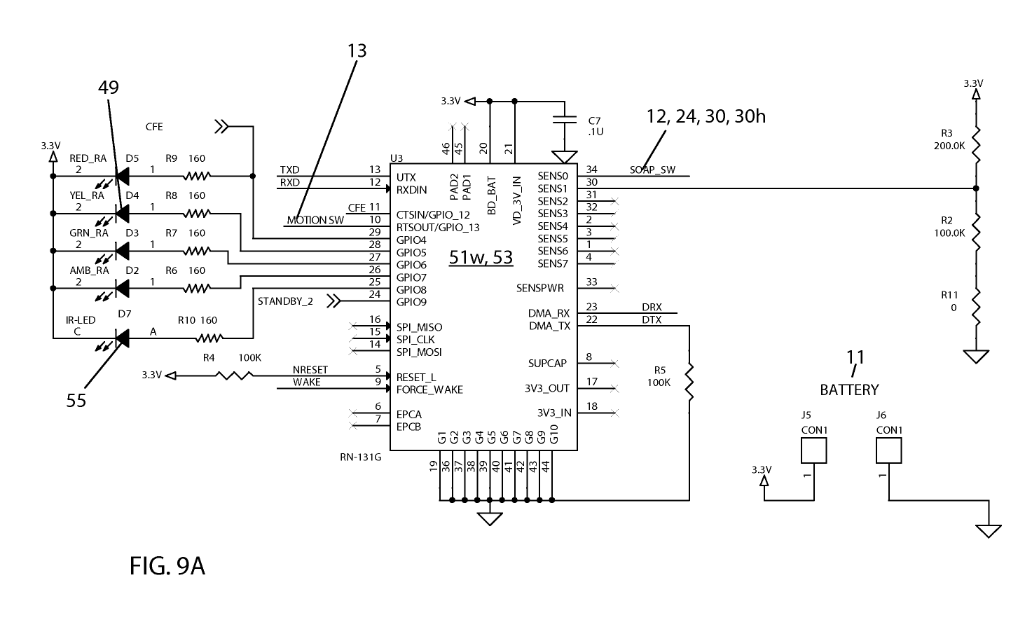

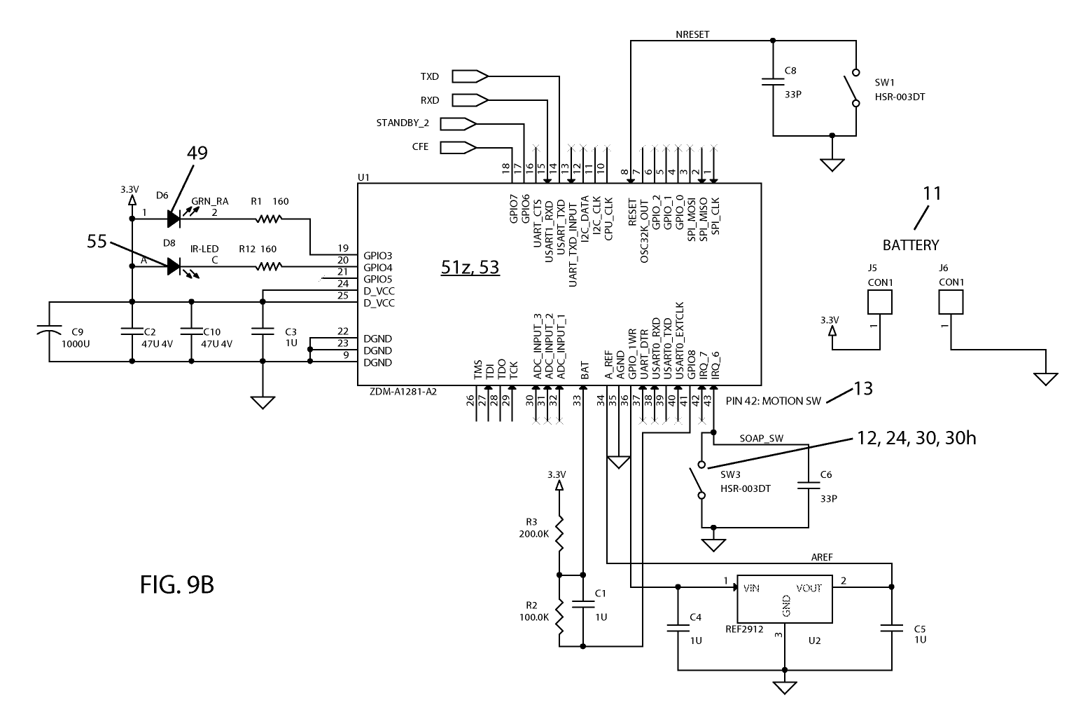

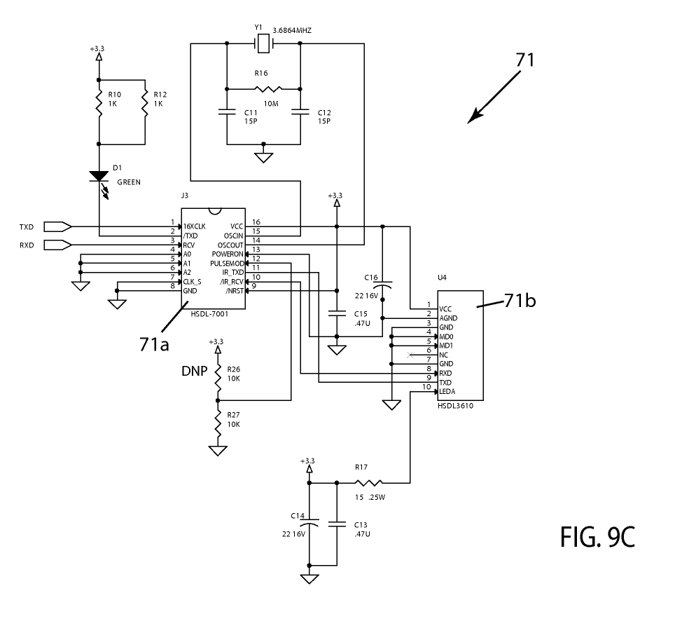

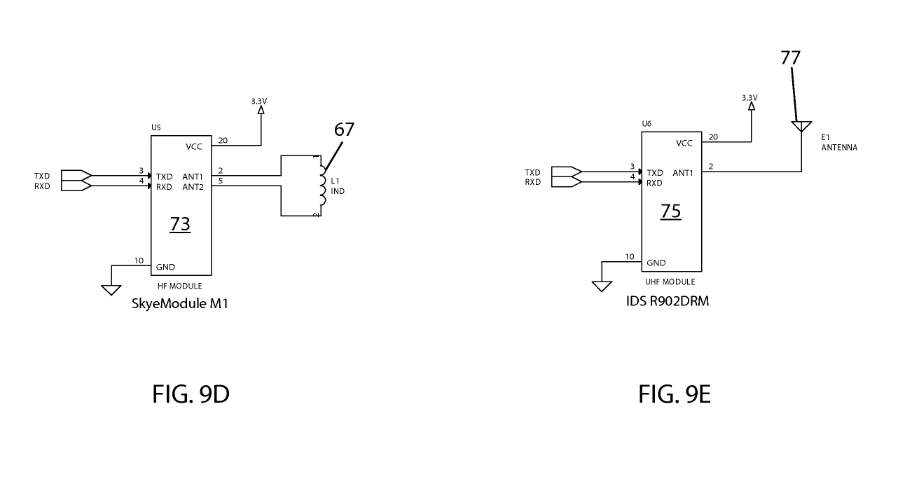

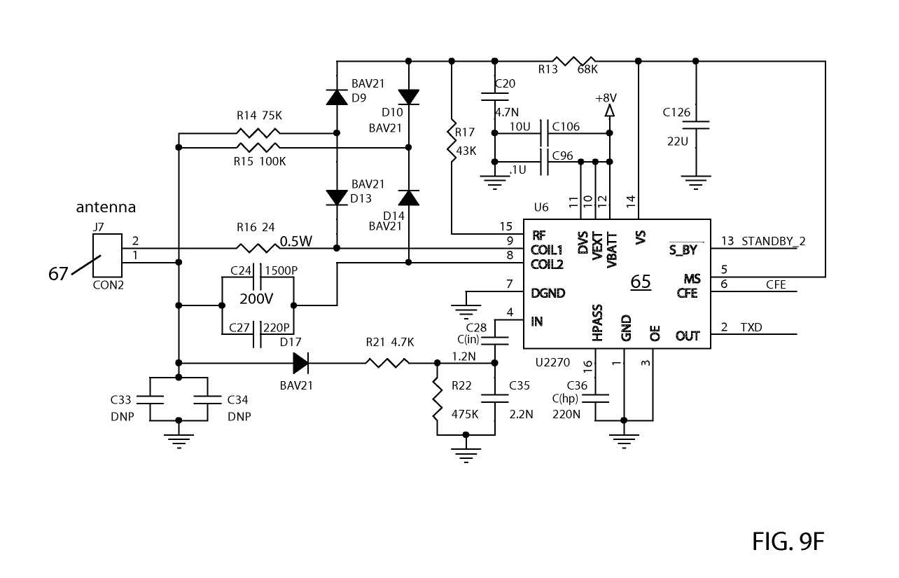

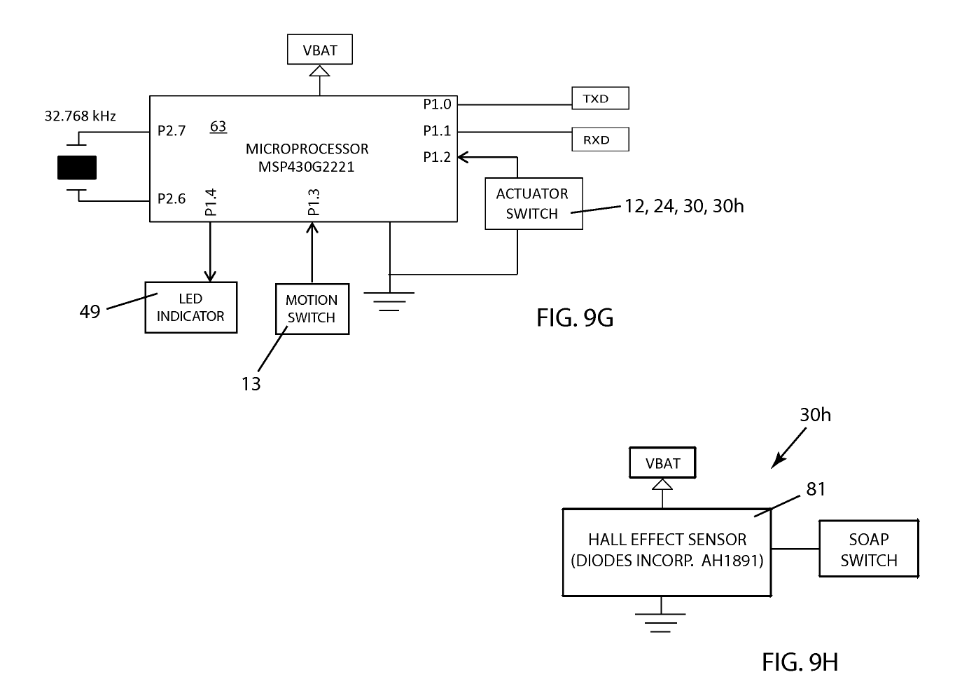

FIGS. 5 and 6 also illustrate an embodiment of apparatus 1 in which the dispense sensor is a Hall effect sensor 30h. In such an embodiment, wireform assembly 3 of course includes magnet 6 as shown in FIGS. 2 and 2A. See also FIG. 9H.

FIG. 7 is a top elevation drawing of enclosure 19 and dispenser mounting clip 18 illustrating that enclosure 19 and mounting clip 18 may be removably attached to one another. In order to accommodate different bottle cap sizes using the same apparatus enclosure 19, different sized clips 18 may be used or cap 2 may be configured to have enclosure 19 mounted directly to cap 2.

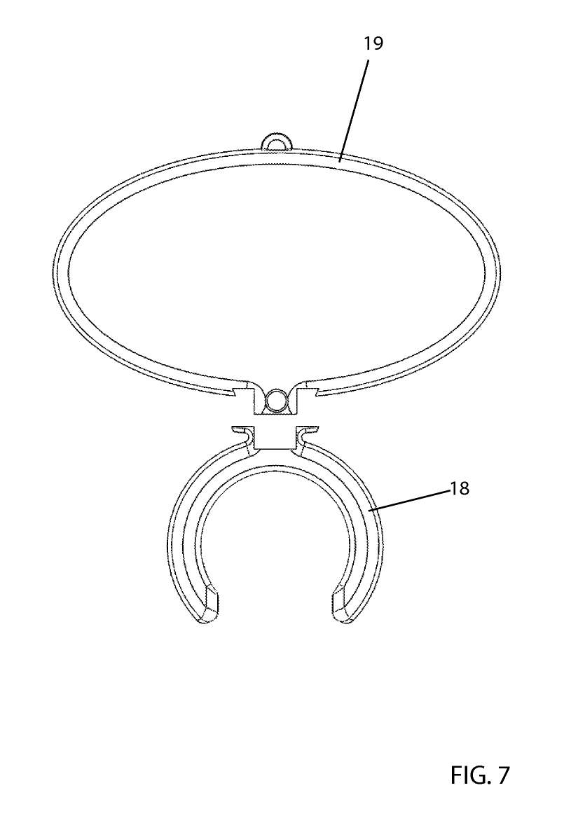

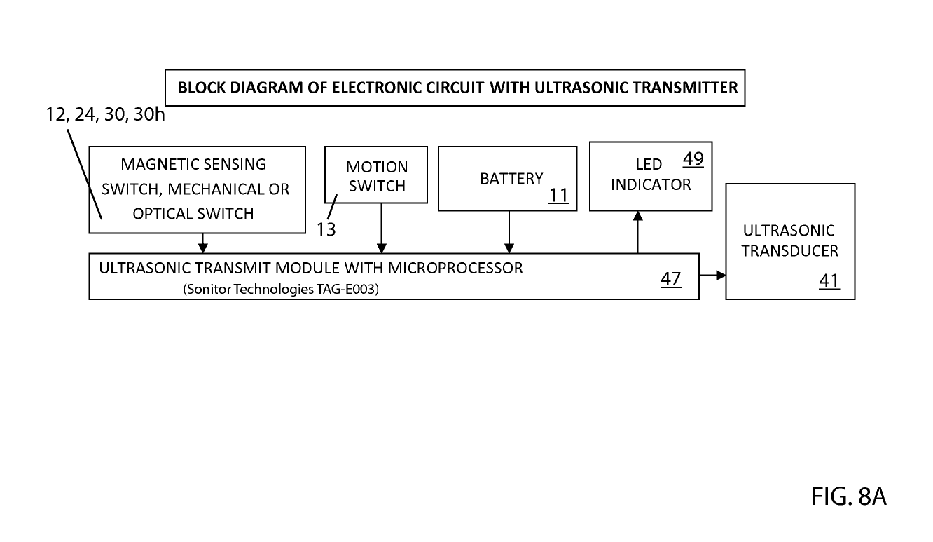

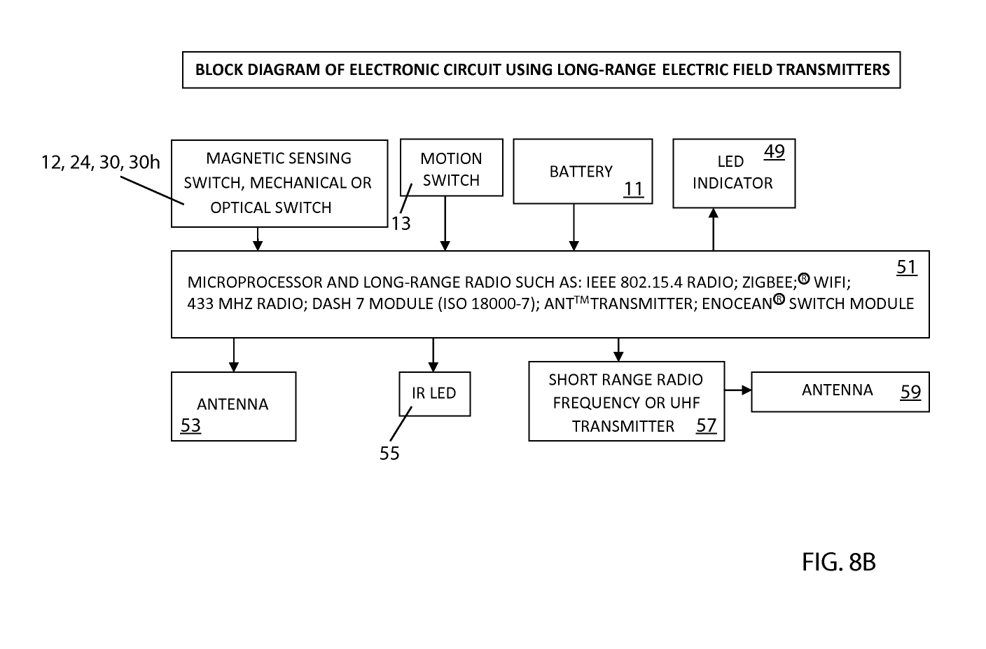

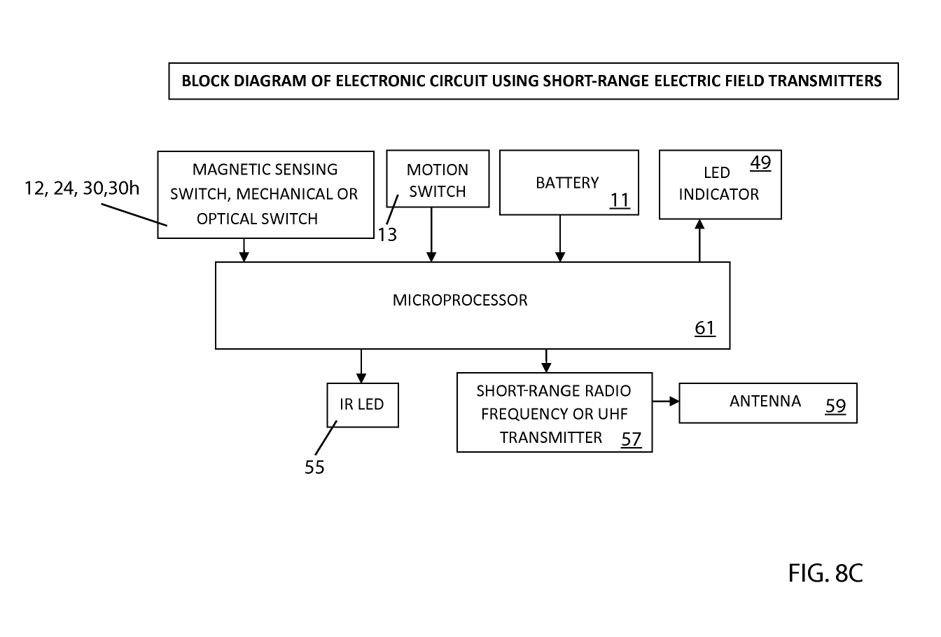

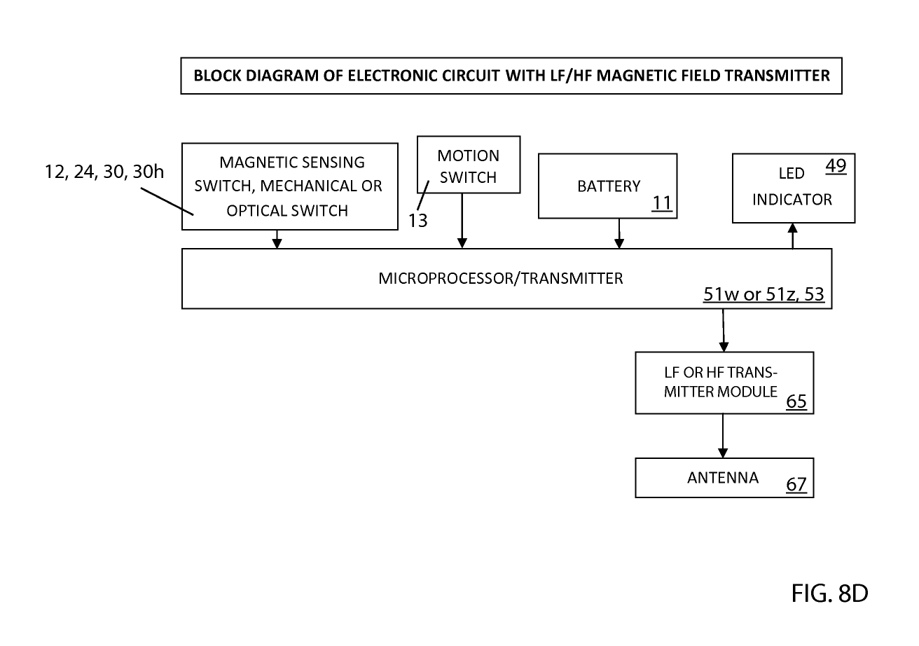

FIGS. 8A through 8D are block diagram schematics of alternative embodiments of apparatus 1. Each of the embodiments shown in these four block diagrams include dispense sensor (12, 24, 30 or 30h) and motion switch 13 providing inputs to a microprocessor. Among other functions, the microprocessor is configured and programmed to respond to the dispense sensor by transmitting a signal including a unique identification code associated with apparatus 1 via the wireless transmitter of each particular embodiment. Each embodiment also includes battery 11 as its power source and an LED indicator 49 to indicate actuation. The microprocessor may also be configured and programmed to cause transmission of battery level data and motion switch data.

The embodiment of the block diagram of FIG. 8A includes an ultrasonic transmitter. The wireless transmitter may be part of a module 47 (TAG-E003) provided by Sonitor Technologies of Bothell, Wash. Module 47 includes a microprocessor and ultrasonic transmitter in a single unit and drives an ultrasonic transducer 41 to effect transmission.

The embodiment of the block diagram of FIG. 8B includes a long-range electric field transmitter 51 (several exemplary modalities shown, without limitation, and as integrated with the microprocessor) with an optional IR transmitter 55. Long-range electric field transmission uses an antenna 53. If a short-range or UHF transmitter 57 is also utilized, an antenna 59 is used.

The embodiment of the block diagram of FIG. 8C includes short-range electric field transmitter 57 with antenna 59 and/or IR transmitter 55.

The embodiment of the block diagram of FIG. 8D includes a magnetic field transmitter and an RF transmitter. Two exemplary alternative modalities for the RF transmitter are shown in FIG. 8D as using microprocessor/transmitter 51w (WiFi) or 51z (ZigBee) (see FIGS. 9A and 9B) in conjunction with antenna 53 and a low- or high-frequency transmitter 65 and antenna 67 for magnetic field transmission. Apparatus 1 on bottle 17 (not shown in this figure) includes coil antenna 67. Bottle 17 may be larger in such an embodiment, and coil antenna 67 may be embedded in a larger enclosure to accommodate the large size of antenna 67.

FIGS. 9A through 9G are circuit diagrams of various embodiments of electronic circuit 10 of apparatus 1. Several such embodiments include a microprocessor either as a separate component or as part of integrated module which may include other transmitter elements.

FIG. 9A is a circuit diagram of a WiFi transmitter embodiment of electronic circuit 10 in apparatus 1. WiFi module 51w including antenna 53 may be an RN-131G module available from Roving Networks of Los Gatos, Calif. Dispense sensor 12, 24, 30, 30h is an input to module 51w at pin 34; motion sensor 13 is an input at pin 10; LED indicator 49 is an output element at pin 28; and IR LED 55 is an output at pin 25. Antenna 53 is embedded in module 51w as indicated.

FIG. 9B is a circuit diagram of a Zigbee transmitter embodiment of electronic circuit 10 in apparatus 1. ZigBee module 51z including antenna 53 may be a Meshnetics ZDM-A1281-A2 module available from Atmel Corporation of San Jose, Calif. Dispense sensor 12, 24, 30, 30h is an input to module 51z at pin 43; motion sensor 13 is an input at pin 42; LED indicator 49 is an output element at pin 19; and IR LED 55 is an output at pin 20. Antenna 53 is embedded in module 51w as indicated.

FIG. 9C is a circuit diagram of an infrared transmitter embodiment of electronic circuit 10 in apparatus 1. An exemplary IR circuit transmit and receive circuit 71 may include an HSDL-7001 encoder/decoder 71 a and an HSDL3610 transceiver 71b, both available from Avago Technologies of San Jose, Calif. Circuit 71 is used in conjunction with a microprocessor 63 as shown in FIG. 9G. Microprocessor 63 may be an MSP430G2221 chip available from Texas Instruments of Dallas, Tex. Referring to FIGS. 9C and 9G, dispense sensor 12, 24, 30, 30h is an input to pin P1.2 of microprocessor 63; motion sensor 13 is an input at pin P1.3; and LED indicator 49 is an output element at pin P1.4. The circuits of FIG. 9C and 9G connect at the points labeled TXD (transmit enable) and RXD (receive enable).

FIG. 9D is a circuit diagram of a high-frequency magnetic field transmitter embodiment of electronic circuit 10 in apparatus 1. A high-frequency module 73 in such embodiment may be a SkyeModule M1 (13.56 MHZ) available from Skyetek of Denver, Colo. A coil antenna 67 is attached to module 73. In a fashion similar to the circuit of FIG. 9C, microprocessor 63 and other elements of the circuit of FIG. 9G are used in conjunction with the circuit of FIG. 9D. The circuits of FIG. 9D and 9G connect at the points labeled TXD (transmit enable) and RXD (receive enable).

FIG. 9E is a circuit diagram of an ultra-high-frequency RF transmitter embodiment of electronic circuit 10 in apparatus 1. A ultra-high-frequency module 75 in such embodiment may be an IDS R902DRM integrated circuit available from IDS Microchip AG of Wollerau SZ, Switzerland. An antenna 77 is attached to module 75. In a fashion similar to the circuit of FIG. 9C, microprocessor 63 and other elements of the circuit of FIG. 9G are used in conjunction with the circuit of FIG. 9E. The circuits of FIG. 9E and 9G connect at the points labeled TXD (transmit) and RXD (receive).

FIG. 9F is a circuit diagram of low-frequency RF transmitter embodiment of electronic circuit 10 in apparatus 1. A low-frequency module 65 in such embodiment may be an integrated circuit chip U2270 available from Atmel Corporation of San Jose, Calif. A coil antenna 67 is employed in this embodiment 65. In a fashion similar to the circuit of FIG. 9C, microprocessor 63 and other elements of the circuit of FIG. 9G are used in conjunction with the circuit of FIG. 9F. The circuits of FIG. 9F and 9G connect at the points labeled TXD (transmit enable), CFE (carrier frequency enable) and STANDBY_{—}2 (standby enable).

FIG. 9H is a circuit diagram of Hall effect sensor 30h adapted to serve a dispense sensor. The Hall effect module may be an AH1891 chip available from Diodes Incorporated of Plano, Tex. During actuation, magnet 6 in wireform assembly 3 moves adjacent to chip 81, and causes switching action within sensor 30h. Sensor 30h can be adapted to the circuits illustrated in FIGS. 9A through 9G.

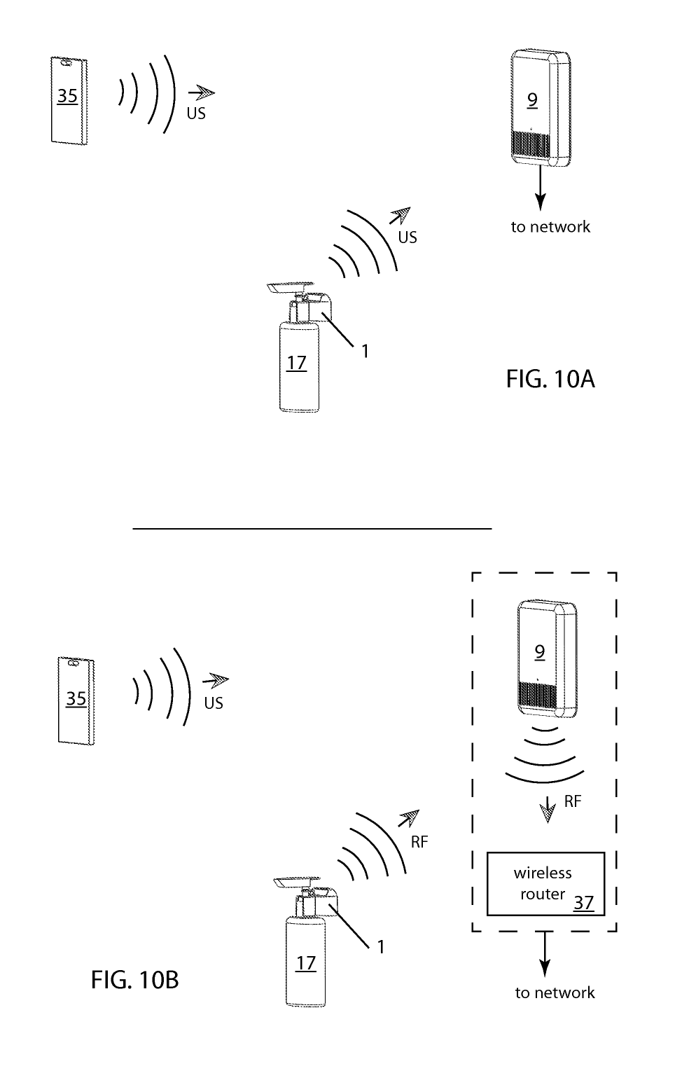

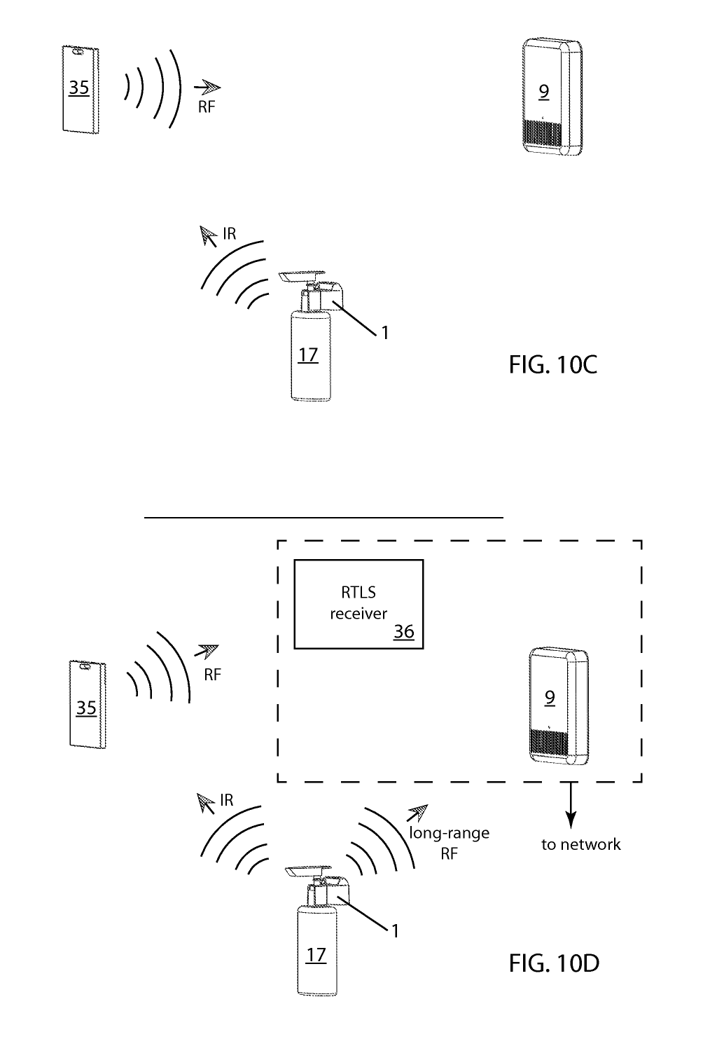

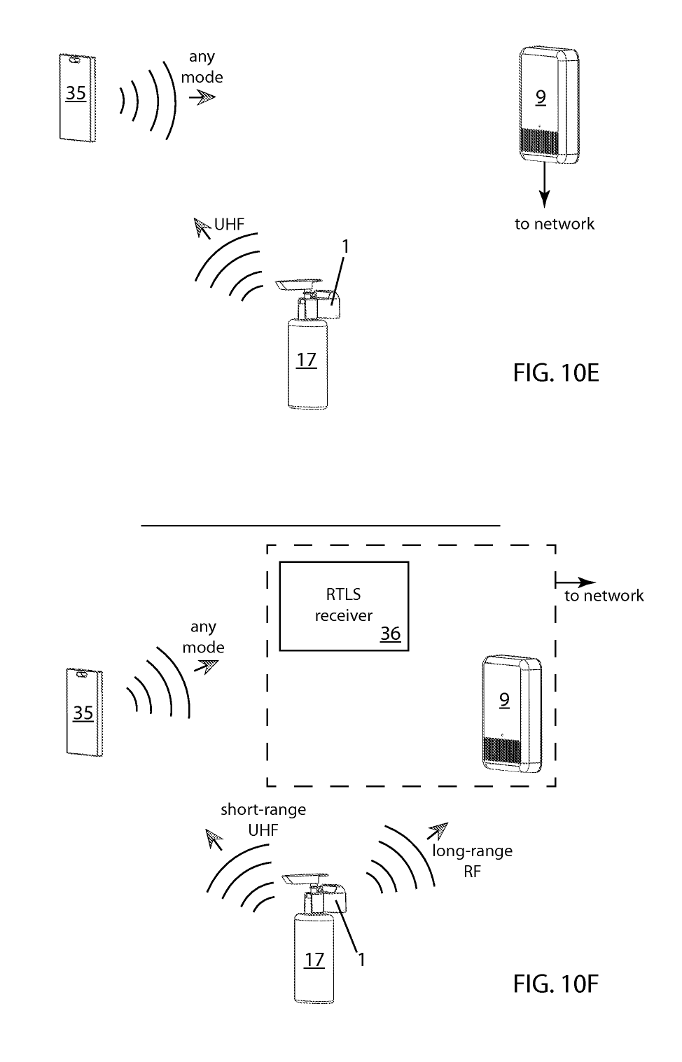

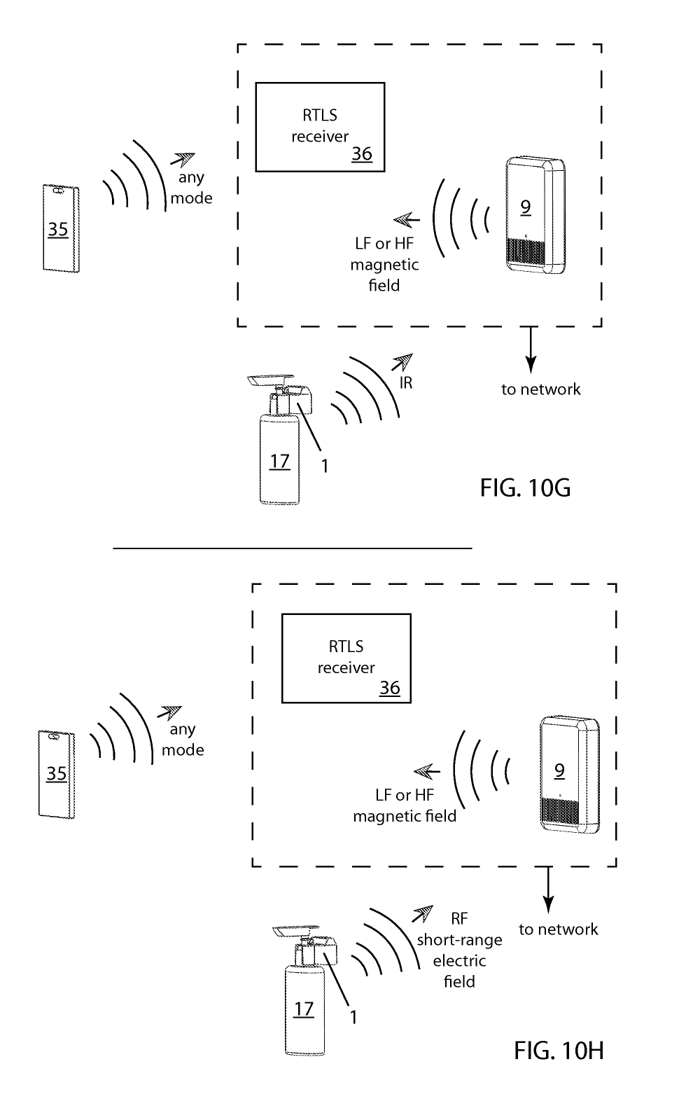

FIGS. 10A through 10H illustrate embodiments of the inventive hand-hygiene monitoring system incorporating actuation sensor apparatus 1. In each of these figures, an icon composed of sectors of concentric circles indicates wireless communication between system components. Each icon has a direction indicated by an arrow and an abbreviation indicating the mode of signal transmission being used. For example, the abbreviation “US” in such icons indicates that an ultrasonic signal is being transmitted. Other abbreviations have been defined previously in this document.

Each of the monitoring systems in the schematic diagrams of FIGS. 10A through 10H includes apparatus 1 attached to liquid-dispensing bottle 17, a real-time location system (RTLS) tag 35, and a base unit 9 configured to receive wireless signals from one or more of the other components in the system. Base unit 9 may be conveniently mounted on a wall or ceiling. Base unit 9 may also include an RTLS receiver, and such receiver may be a physical unit separate from the unit indicated by reference number 9 but may also be physically integrated into a single unit. Thus, base unit 9, when also including RTLS receiver 35 or other such additional unit, is indicated schematically with a dotted line surrounding both physical units. Together they constitute base unit 9 in this document. In one other instance (see FIG. 10B), base unit 9 includes a wireless router 37. As before, base unit 9 includes router 37, and the physical units may or may not be integrated into a single physical unit.

Each system illustrated in FIGS. 10A through 10H also includes a connection to a network. Such network represents the data gathering/storing portion of the hand-hygiene systems shown. The network may communicate, without limitation, via a hardwired link or may be connected wirelessly, both such communication modes being well known to those skilled in the area of information systems.

RTLS tags 35 are typically worn by users in a working environment such as a health-care or food-preparation facility, and the purpose of the RTLS system in the context of this invention is to be able to identify which user has been the one actuating apparatus 1. Other portions of the system, including apparatus 1, provide information regarding the location of apparatus 1. Thus, data transmitted back to the network includes the identity of the user actuating apparatus 1 in a known location.

The block diagrams of FIGS. 8A through 8D and the circuit diagrams of FIGS. 9A through 9G are among the embodiments of apparatus 1 depicted in FIGS. 10A through 10H. Transmitter modules which operate in any of the modes (ultrasonic, IR, RF, UHF, etc.) are well-known to those skilled in the art of data communications.

Referring to FIG. 10A, the embodiment of a hand-hygiene monitoring system shown includes ultrasonic transmitters in apparatus 1 and in tag 35. Such ultrasonic modules may be supplied by Sonitor Technologies of Bothell, Wash. Base unit 9 includes an ultrasonic module configured to receive ultrasonic signals from both apparatus 1 and tag 35.

FIG. 10B is a schematic drawing depicting an embodiment of a hand-hygiene monitoring system incorporating an RF transmitter in apparatus 1 and an ultrasonic transmitter in tag 35. Base unit 9 is configured to receive both such signals. Base unit 9 includes wireless router 37 which receives data internally in base unit 9 as a wireless RF signal. Thus the two physical components of base unit 9 may be physically separated and in fact may not even be located in the same room.

Referring to FIG. 10C, the embodiment of a hand-hygiene monitoring system shown includes an infrared transmitter in apparatus 1 and an RF transmitter in tag 35. Tag 35 is configured to receive an infrared signal from apparatus 1 and to transmit to base unit 9 using an RF signal.

FIG. 10D is a schematic drawing illustrating an embodiment of a hand-hygiene monitoring system incorporating two transmitters in apparatus 1, an infrared transmitter to communicate with tag 35 and a long-range RF transmitter to communicate with base unit 9. Base unit 9 receives data from tag 35 via an RF signal via RTLS receiver 36. The two transmitters in apparatus 1 enables dispenser usage to be monitored independently of the RTLS subsystem.

The embodiments shown schematically in FIGS. 10E through 10H are likewise variants of the general architectures described in FIGS. 10A through 10D. In these figures, tag 35 having a transmitter labeled “any mode” indicates that tag 35 may be configured to include any one of the transmitter modes indicated in these embodiments (US, IR, RF, UHF, etc.). The embodiment of FIG. 10E incorporates a UHF transmitter in apparatus 1. In the embodiment of FIG. 10F, apparatus 1 incorporates a short-range UHF transmitter to communicate with tag 35 and a long-range RF transmitter to communicate with base unit 9. Tag 35 communicates with RTLS receiver 36 in base unit 9. The two transmitters in apparatus 1 enables dispenser usage to be monitored independently of the RTLS subsystem.

The embodiments of the hand-hygiene monitoring systems illustrated in FIGS. 10G and 10H include a low- or high-frequency magnetic field transmitter in base unit 9, which also includes RTLS receiver 36. In these embodiments, base unit 9 serves as a relay between apparatus 1 and tag 35 or RTLS receiver 36 (within base unit 9). The LF or HF magnetic field transmission has only a very short useful range and thus is configured to communicate only with a tag 35 which is immediately within range of base unit 9. When apparatus 1 is actuated, a signal (IR in FIG. 10G and RF in FIG. 10H) is transmitted to base unit 9 which in turn transmits only to a tag 35 close enough to base unit 9 to be the tag 35 worn by the user who actuated apparatus 9. Thus the accuracy of the hand-hygiene monitoring system is enhanced, eliminating possible confusion from multiple users wearing tags within a room being monitored.

A typical antenna for an LF (124-134 kHz) or HF (13.56 MHz) magnetic field transmission with approximately a one-meter range is too large to fit in a suitably-sized apparatus 1. Thus, in order to transmit data from apparatus 1 to tag 35, base unit 9 is configured to “relay” data from apparatus 1 to a tag 35 which is in close proximity to base unit 9. Apparatus 1 may utilize one of a number of transmission means to communicate with base unit 9 which then transmits an LF or HF signal that uses a magnetic field to communicate to tag 35.

While the principles of this invention have been described in connection with specific embodiments, it should be understood clearly that these descriptions are made only by way of example and are not intended to limit the scope of the invention.

1. Actuation sensor apparatus configured to removably attach to a liquid dispenser, the apparatus comprising:
an electronic circuit including a dispense sensor and a wireless transmitter; and
a power supply for the electronic circuit,
whereby, when dispenser actuation occurs, an identification code unique to the apparatus is wirelessly transmitted to a receiver.

2. The actuation sensor apparatus of claim 1 wherein the dispense sensor is a magnetic sensor and the apparatus further includes an actuator arm having a magnet, the actuator arm being configured to move with respect to the magnetic sensor during actuation.

3. The actuation sensor apparatus of claim 2 wherein at least a portion of the actuator arm is over-molded with a polymer material.

4. The actuation sensor apparatus of claim 2 wherein at least a portion of the actuator arm is inserted into a heat-shrink sleeve.

5. The actuation sensor apparatus of claim 2 wherein the actuator arm removably attaches to the liquid dispenser with a wireform assembly.

6. The actuation sensor apparatus of claim 2 wherein the magnetic sensor is a reed switch.

7. The actuation sensor apparatus of claim 2 wherein the magnetic sensor is an integrated circuit.

8. The actuation sensor apparatus of claim 7 wherein the integrated circuit includes a Hall effect sensor.

9. The actuation sensor apparatus of claim 1 wherein the wireless transmitter is an electric field transmitter.

10. The actuation sensor apparatus of claim 1 wherein the wireless transmitter is an ultrasonic transmitter.

11. The actuation sensor apparatus of claim 1 wherein the wireless transmitter is an infrared transmitter.

12. The actuation sensor apparatus of claim 1 wherein the wireless transmitter is a magnetic field transmitter.

13. The actuation sensor apparatus of claim 12 wherein the magnetic field transmitter is a low-frequency transmitter.

14. The actuation sensor apparatus of claim 12 wherein the magnetic field transmitter is a high-frequency transmitter.

15. The actuation sensor apparatus of claim 1 further including a motion sensor whereby the wireless transmitter transmits a signal when the apparatus is moved for at least a predetermined time period.

16. The actuation sensor of claim 15 wherein the predetermined time period is at least about two seconds, thereby to allow non-theft movements to be overlooked.

17. The actuation sensor apparatus of claim 1 further including an electronic circuit enclosure and a dispenser mounting clip, the enclosure and clip being removably attached to each other.

18. The actuation sensor apparatus of claim 1 further including an electronic circuit enclosure which is sealed to prevent liquid from contacting the electronic circuit.

19. The actuation sensor apparatus of claim 1 wherein the power source is a battery.

20. The actuation sensor apparatus of claim 19 wherein the battery is rechargeable.

21. The actuation sensor apparatus of claim 1 wherein the electronic circuit is configured to transmit the battery-charge level upon dispenser actuation.

22. The actuation sensor apparatus of claim 1 wherein the power source comprises circuitry to generate electric power by converting mechanical energy to electric energy during dispenser actuation.

23. The actuation sensor apparatus of claim 22 wherein the electronic circuit, dispense sensor and power source are an integrated unit.

24. The actuation sensor apparatus of claim 1 wherein the electronic circuit enters an ultra-low-power mode between dispenser actuations.

25. The actuation sensor apparatus of claim 1 wherein the dispense sensor is a mechanical switch.

26. The actuation sensor apparatus of claim 1 wherein the dispense sensor is an optical sensor in which a light beam is interrupted by dispenser activation.

27. A hand-hygiene monitoring system comprising:
actuation sensor apparatus configured to removably attach to a liquid dispenser, the apparatus comprising:
an electronic circuit including a dispense sensor and a wireless transmitter; and
a power supply for the electronic circuit,
a plurality of real-time location system tags, each tag associated with a particular user; and
a base unit configured to communicate with one or more of the actuation sensor apparatus and the plurality of tags and to communicate with a network,
whereby, when dispenser actuation by one of the plurality of users occurs, identification codes unique to the apparatus and to the one of the plurality of users are transmitted to the network.

28. The hand-hygiene monitoring system of claim 27 wherein the dispense sensor is a magnetic sensor and the apparatus further includes an actuator arm having a magnet, the actuator arm being configured to move with respect to the magnetic sensor during actuation.

29. The hand-hygiene monitoring system of claim 27 wherein:
the wireless transmitter is an infrared transmitter;
the base unit includes a short-range magnetic field transmitter and an real-time location system receiver; and
the base unit is configured to transmit data received from the actuation sensor apparatus to one of the plurality of tags when the dispenser is actuated.

30. The hand-hygiene monitoring system of claim 27 wherein:
the wireless transmitter is an electric field transmitter;
the base unit includes a short-range magnetic field transmitter and an real-time location system receiver; and
the base unit is configured to transmit data received from the actuation sensor apparatus to one of the plurality of tags when the dispenser is actuated.
